(19) United States
(12) Patent Application Publication
(10) Pub. No.: US 2016/0331631 A1
(43) Pub. Date: Nov. 17, 2016

(54) MASSAGE ASSEMBLY

(71) Applicant: Hezekiah Odi, Glen Burnie, MD (US)

(72) Inventor: Hezekiah Odi, Glen Burnie, MD (US)

(21) Appl. No.: 14/711,918

(22) Filed: May 14, 2015

(51) Int. Cl. A61H 23/02; A61H 15/00

(52) U.S. Cl. CPC A61H 23/02; A61H 15/0078; A61H 2015/0007

(57) ABSTRACT

A massage assembly includes a plurality of sections and each of the sections has a first end, a second end and a peripheral wall extending between the first end and the second end. The peripheral wall of each of the sections is arcuate between the first end and the second end such that each of the plurality of sections has a substantially cylindrical shape. The peripheral wall of each of the sections has an inner surface and an outer surface. The first end of each of the sections is open such each of the sections may have a leg of a user extended therein. A plurality of massage units is provided and each of the massage units is attached to an associated one of the sections. Each of the massage units is positioned within the peripheral wall of the associated section. Thus, each of the massage units may engage the user's leg when each of the associated sections is worn on the user's leg.

### BACKGROUND OF THE DISCLOSURE

### Field of the Disclosure

The disclosure relates to massage devices and more particularly pertains to a new massage device for massaging a leg of a user.

### SUMMARY OF THE DISCLOSURE

An embodiment of the disclosure meets the needs presented above by generally comprising a plurality of sections and each of the sections has a first end, a second end and a peripheral wall extending between the first end and the second end. The peripheral wall of each of the sections is arcuate between the first end and the second end such that each of the plurality of sections has a substantially cylindrical shape. The peripheral wall of each of the sections has an inner surface and an outer surface. The first end of each of the sections is open such each of the sections may have a leg of a user extended therein. A plurality of massage units is provided and each of the massage units is attached to an associated one of the sections. Each of the massage units is positioned within the peripheral wall of the associated section. Thus, each of the massage units may engage the user's leg when each of the associated sections is worn on the user's leg.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a massage assembly according to an embodiment of the disclosure.

FIG. 2 is a front view of an embodiment of the disclosure.

FIG. 3 is a cross sectional view taken along line 3-3 of FIG. 2 of knee section of an embodiment of the disclosure.

FIG. 4 is a right side phantom view of a knee section of an embodiment of the disclosure.

FIG. 5 is a schematic view of an embodiment of the disclosure.

FIG. 6 is a cross sectional view taken along line 6-6 of FIG. 1 of calf section of an embodiment of the disclosure.

FIG. 7 is a cross sectional view taken along line 7-7 of FIG. 1 of a foot section of an embodiment of the disclosure.

### DESCRIPTION OF THE PREFERRED EMBODIMENT

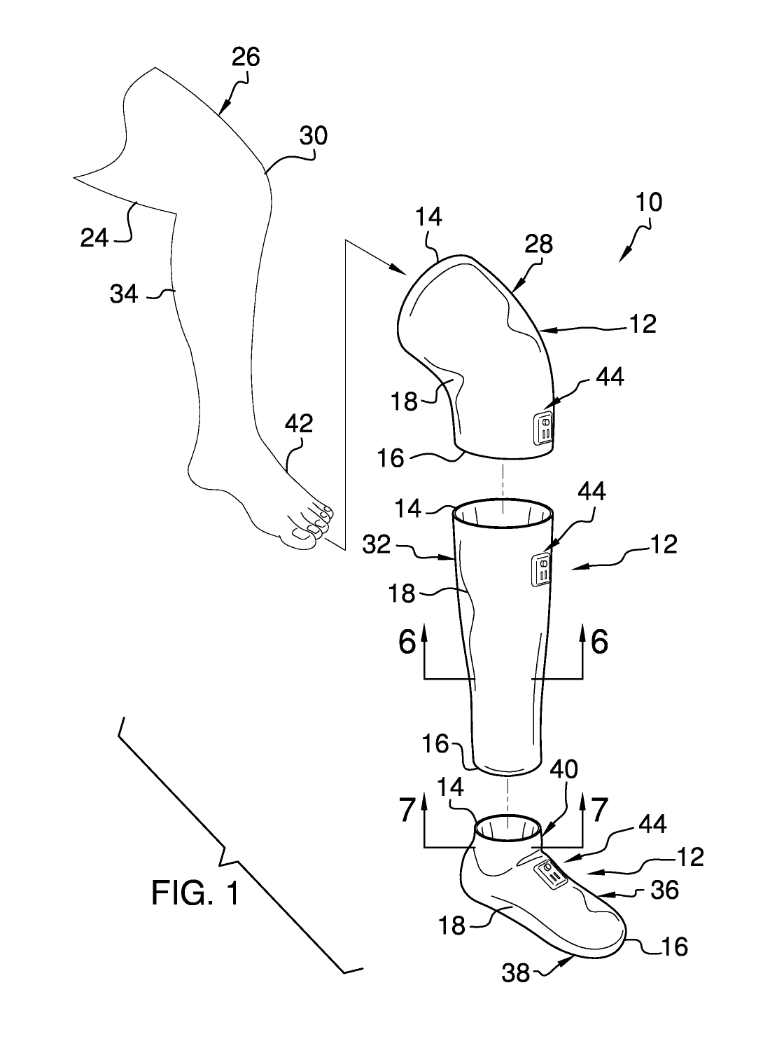

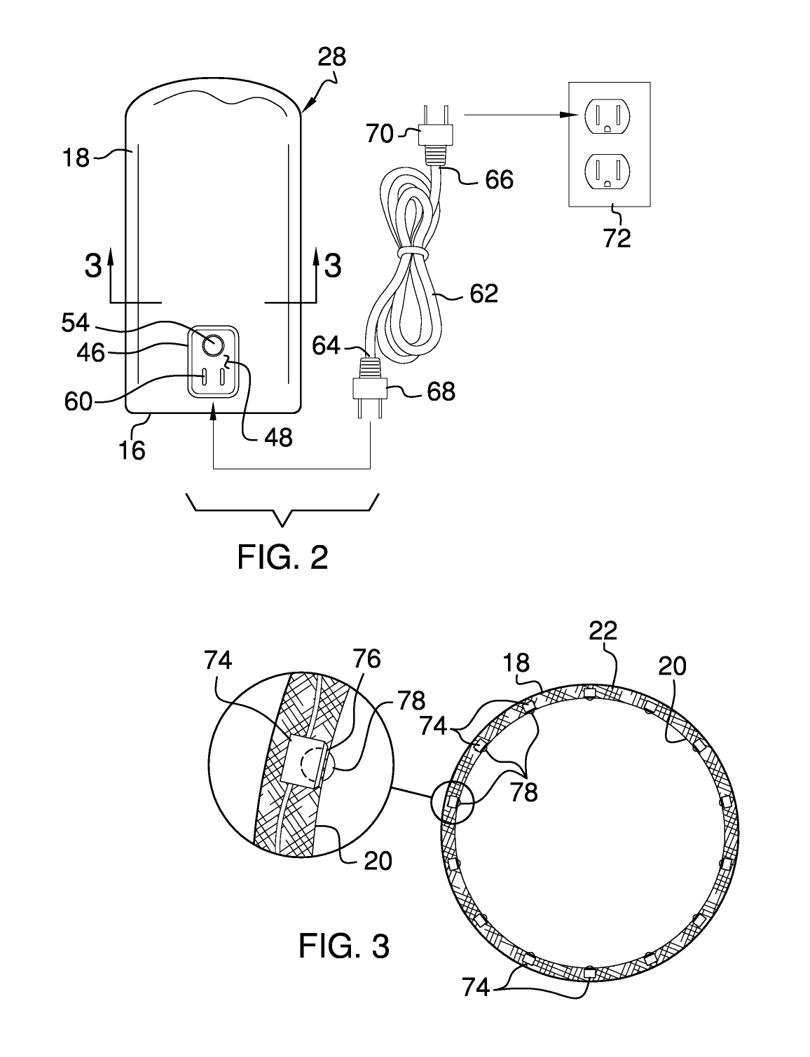

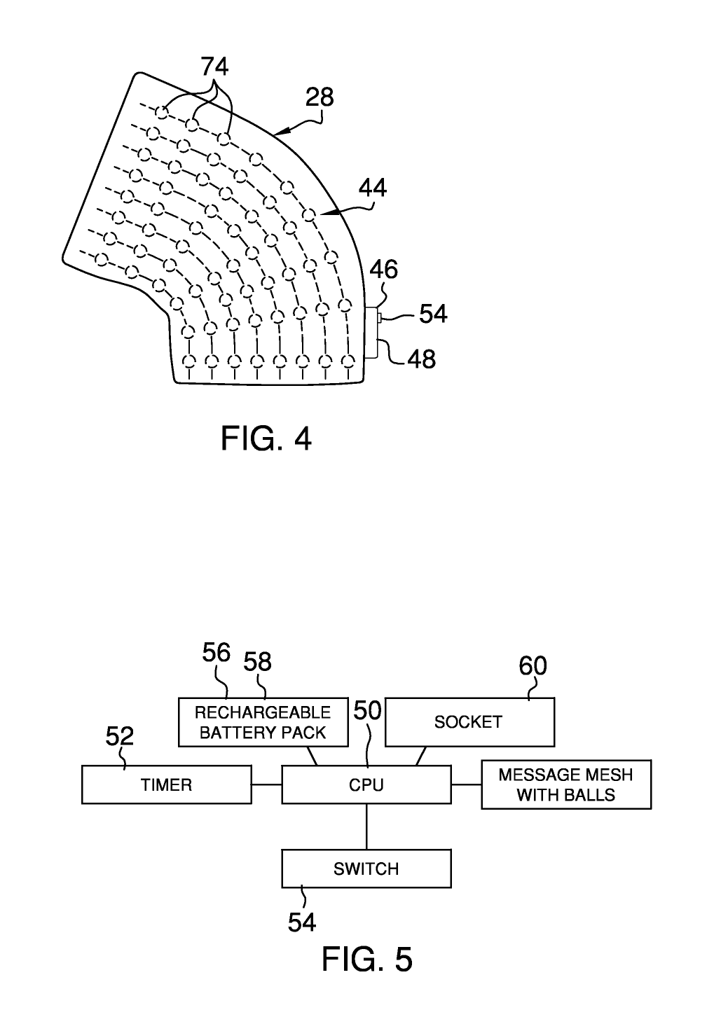

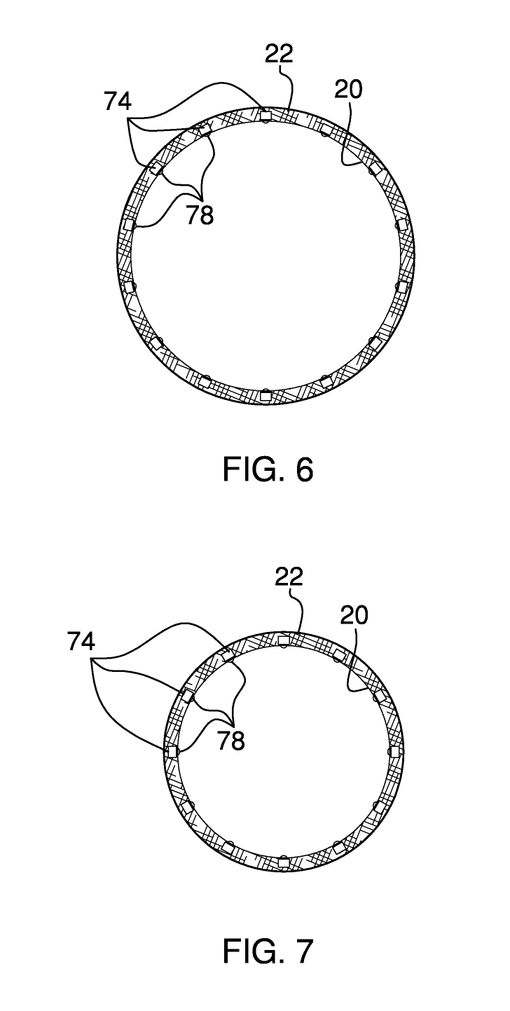

With reference now to the drawings, and in particular to FIGS. 1 through 7 thereof, a new massage device embodying the principles and concepts of an embodiment of the disclosure and generally designated by the reference numeral 10 will be described.

As best illustrated in FIGS. 1 through 7, the massage assembly 10 generally comprises a plurality of sections 12 and each of the sections 12 has a first end 14, a second end 16 and a peripheral wall 18 extending between the first end 14 and the second end 16. The peripheral wall 18 of each of the sections is arcuate between the first end 14 and the second end 16 such that each of the plurality of sections 12 has a substantially cylindrical shape. The peripheral wall 18 of each of the sections 12 has an inner surface 20 and an outer surface 22. The first end 14 of each of the sections 12 is open such that each of the sections 12 may have a leg 24 of a user 26 extended therein. Each of the plurality of sections 12 may be comprised of a resiliently stretchable material such as nylon or the like.

The plurality of sections 12 comprises a knee section 28 and the second end 16 of the knee section 28 is open. Thus, the knee section 28 may be worn around the user's knee 30. The plurality of sections 12 additionally comprises a calf section 32 and the second end 16 of the calf section 32 is open. Thus, the calf section 32 may be worn around the user's lower leg 34. Finally, the plurality of sections 12 further comprises a foot section 36 that has a toe portion 38 and an ankle portion 40. Thus, the foot section 36 may be worn on the user's foot 42.

A plurality of massage units 44 is provided and each of the massage units 44 is attached to an associated one of the sections 12. Each of the massage units 44 is positioned within the peripheral wall 18 of the associated section 12. Thus, each of the massage units 44 engages the user's leg 24 when each of the associated sections 12 is worn on the user's leg 24. Each of the massage units 44 includes a control unit 46 that is attached to the outer surface 22 the associated section 12. The control unit 46 has an exposed face 48 with respect to the outer surface 22.

A control circuit 50 is positioned within the control unit 46 and the control circuit 50 may comprise an electronic processor or the like. A timer 52 is positioned within the control unit 46 and the timer 52 is electrically coupled to the control circuit 60. The timer 52 may comprise an electronic timer or the like and the timer 52 de-actuates the control circuit 50 after a pre-determined duration of time. The pre-determined duration of time may range between approximately ten minutes and sixty minutes. A switch 54 is positioned on the exposed face 48 of the control unit 46 such that the switch 54 may be manipulated. The switch 54 is electrically coupled to the control circuit 50 such that the switch 54 selectively actuates the control circuit 50.

A power supply 56 is positioned within the control unit 46 and the power supply 56 is electrically coupled to the control circuit 50. The power supply 56 comprises at least one battery 58 and the battery 58 may comprise a rechargeable battery or the like. A socket 60 is positioned on the exposed face 48 and the socket 60 is electrically coupled to the power supply 56.

A power cord 62 is provided that has a first end 64 and a second end 66. The first end 64 has a first plug 68 that is electrically coupled thereto and the second end 66 has a second plug 70 that is electrically coupled thereto. The first plug 68 is selectively electrically coupled to the socket 60 and the second plug 70 may be electrically coupled to a power source 72 such that the power cord 62 charges the battery 58. The power source 72 may be an electrical outlet or the like.

A plurality of actuators 74 is provided and each of the actuators 74 is positioned within the peripheral wall 18 of an associated one of the sections 12. Each of the actuators 74 has an inwardly facing surface 76 and the inwardly facing surface 76 is aligned with the inner surface 20 of the associated section 12. The actuators 74 are spaced apart from each other and distributed between the first end 14 and the second end 16 of the associated section 12. The actuators 74 are distributed around an entire circumference of the associated section 12 and each of the actuators 74 of each of the associated sections 12 is electrically coupled together. Each of the actuators 74 is electrically coupled to the control circuit 50 of the associated section 12. Each of the actuators 74 may comprise electrically actuated actuators or the like.

A plurality of balls 78 is provided and each of the balls 78 is mechanically coupled to an associated one of the actuators 74 of the associated section 12. Each of the balls 78 is positioned on the inwardly facing surface 76 and each of the balls 78 extends through the inner surface 20 of the associated section 12. Thus, each of the balls 78 may engage the user's leg 24. Each of the balls 78 are vibrated by the associated actuator 74 when the control circuit 50 is actuated thereby facilitating each of the balls 78 to massage the user's leg 24.

In use, a selected one of the sections 12 is worn on the associated user's knee 30, the user's lower leg 34 and the user's foot 42. Each of the sections 12 may be worn individually or each of the sections 12 may be worn simultaneously or in any selected combination. The switch 54 on the selected section 12 is actuated thereby facilitating the balls 78 to massage the user's leg 24. The balls 78 may reduce the symptoms of restless leg syndrome by providing continuous physical sensation in the user's leg 24. Additionally, the balls 78 may stimulate circulation within the user's leg 24 thereby reducing the possibility of the formation of blood clots within the user's leg 24.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A massage assembly configured to be worn on an appendage of a user thereby facilitating said assembly to massage the appendage, said assembly comprising:
a plurality of sections, each of said sections having a first end, a second end and a peripheral wall extending between said first end and said second end, said peripheral wall of each of said sections being arcuate between said first end and said second end such that each of said plurality of sections has a substantially cylindrical shape, said peripheral wall of each of said sections having an inner surface and an outer surface, said first end of each of said sections being open wherein each of said sections is configured to have a leg of a user extended therein; and
a plurality of massage units, each of said massage units being attached to an associated one of said sections, each of said massage units being positioned within said peripheral wall of said associated section wherein each of said massage units is configured to engage the user's leg when each of said associated sections is worn on the user's leg.

2. The assembly according to claim 1, wherein said plurality of sections comprises:
a knee section, said second end of said knee section being open wherein said knee section is configured to be worn around the user's knee;
a calf section, said second end of said calf section being open wherein said calf section is configured to be worn around the user's lower leg; and
a foot section having a toe portion and an ankle portion wherein said foot section is configured to be worn on the user's foot.

3. The assembly according to claim 1, wherein each of said massage units comprises a control unit being attached to said outer surface of said peripheral wall of said associated section, said control unit having an exposed face with respect to said outer surface.

4. The assembly according to claim 3, wherein said control unit further comprises a control circuit being positioned within said control unit, a timer being positioned within said control unit, said timer being electrically coupled to said control circuit wherein said timer de-actuates said control circuit after a pre-determined duration of time.

5. The assembly according to claim 4, wherein said control unit further comprises a switch being positioned on said exposed face of said control unit wherein said switch is configured to be manipulated, said switch being electrically coupled to said control circuit wherein said switch selectively actuates said control circuit.

6. The assembly according to claim 5, wherein said control unit further comprises a power supply being positioned within said control unit, said power supply being electrically coupled to said control circuit, said power supply comprising at least one battery, a socket being positioned on said exposed face, said socket being electrically coupled to said power supply.

7. The assembly according to claim 6, wherein said control unit further comprises a power cord having a first end and a second end, said first end having a first plug being electrically coupled thereto, said second end having a second plug being electrically coupled thereto, said first plug being selectively electrically coupled to said socket, said second plug being configured to be electrically coupled to a power source wherein said power cord charges said battery.

8. The assembly according to claim 1, wherein each of said massage units further comprises a plurality of actuators, each of said actuators being positioned within said peripheral wall of an associated one of said sections, each of said actuators having an inwardly facing surface, said inwardly facing surface being aligned with said inner surface.

9. The assembly according to claim 8, wherein said actuators are spaced apart from each other and distributed between said first end and said second end of said associated section, said actuators being distributed around an entire circumference of said associated section.

10. The assembly according to claim 9, wherein:
each of said massage units includes a control circuit; and
each of said actuators of each of said associate sections is electrically coupled together, each of said actuators being electrically coupled to said control circuit of said associated section.

11. The assembly according to claim 10, wherein a plurality of balls, each of said balls being mechanically coupled to an associated one of said actuators of said associated section, each of said balls being positioned on said inwardly facing surface, each of said balls extending through said inner surface of said associated section wherein each of said balls is configured to engage the user's leg, each of said balls being vibrated by said associated actuator when said control circuit is actuated.

12. A massage assembly configured to be worn on an appendage of a user thereby facilitating said assembly to massage the appendage, said assembly comprising:
a plurality of sections, each of said sections having a first end, a second end and a peripheral wall extending between said first end and said second end, said peripheral wall of each of said sections being arcuate between said first end and said second end such that each of said plurality of sections has a substantially cylindrical shape, said peripheral wall of each of said sections having an inner surface and an outer surface, said first end of each of said sections being open wherein each of said sections is configured to have a leg of a user extended therein, each of said plurality of sections comprising:
a knee section, said second end of said knee section being open wherein said knee section is configured to be worn around the user's knee,
a calf section, said second end of said calf section being open wherein said calf section is configured to be worn around the user's lower leg, and
a foot section having a toe portion and an ankle portion wherein said foot section is configured to be worn on the user's foot;
a plurality of massage units, each of said massage units being attached to an associated one of said sections, each of said massage units being positioned within said peripheral wall of said associated section wherein each of said massage units is configured to engage the user's leg when each of said associated sections is worn on the user's leg, each of said massage units comprising:
a control unit being attached to said outer surface of said peripheral wall of said associated section, said control unit having an exposed face with respect to said outer surface, said control unit comprising:
a control circuit being positioned within said control unit,
a timer being positioned within said control unit, said timer being electrically coupled to said control circuit wherein said timer de-actuates said control circuit after a pre-determined duration of time,
a switch being positioned on said exposed face of said control unit wherein said switch is configured to be manipulated, said switch being electrically coupled to said control circuit wherein said switch selectively actuates said control circuit,
a power supply being positioned within said control unit, said power supply being electrically coupled to said control circuit, said power supply comprising at least one battery,
a socket being positioned on said exposed face, said socket being electrically coupled to said power supply, and
a power cord having a first end and a second end, said first end having a first plug being electrically coupled thereto, said second end having a second plug being electrically coupled thereto, said first plug being selectively electrically coupled to said socket, said second plug being configured to be electrically coupled to a power source wherein said power cord charges said battery,
a plurality of actuators, each of said actuators being positioned within said peripheral wall of an associated one of said sections, each of said actuators having an inwardly facing surface, said inwardly facing surface being aligned with said inner surface, said actuators being spaced apart from each other and distributed between said first end and said second end of said associated section, said actuators being distributed around an entire circumference of said associated section, each of said actuators of each of said associate sections being electrically coupled together, each of said actuators being electrically coupled to said control circuit of said associated section, and
a plurality of balls, each of said balls being mechanically coupled to an associated one of said actuators of said associated section, each of said balls being positioned on said inwardly facing surface, each of said balls extending through said inner surface of said associated section wherein each of said balls is configured to engage the user's leg, each of said balls being vibrated by said associated actuator when said control circuit is actuated.
